(19) United States
(12) Patent Application Publication
(10) Pub. No.: US 2009/0184480 A1
(43) Pub. Date: Jul. 23, 2009

(54) INFORMATION BASED CONTROLLING OF CHASSIS HEIGHT OF A VEHICLE

(75) Inventors: Mikael Larsson, Mölndal (SE); Christian Oscarsson, Myggenäs (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/813,223

(22) PCT Filed: Dec. 8, 2005
(86) PCT No.: PCT/SE05/01860

§ 371 Date: Sep. 27, 2007

(30) Foreign Application Priority Data
Dec. 30, 2004 (SE) 0403224-9

(51) Int. Cl. B60G 17/016

(52) U.S. Cl. 280/5.503; 701/213

(57) ABSTRACT

In a method of operating a vehicle system for automatically adjusting the chassis height of a vehicle, height adjusting devices are operated for adjusting the chassis height in relation to one or more axles of the vehicle from a first height level to second height level. The operation of height adjusting devices is controlled by positioning identification devices so as to move the chassis from the first to the second height level in response to receiving from the position identification devices an indication to the effect that the vehicle is approaching or has arrived at one of a plurality of predetermined positions and/or positions fulfilling predetermined criteria. The predetermined positions may be defined by wireless position indicators to be detected by a position detector installed in the vehicle. The position identification devices can include a global navigation system.

### BACKGROUND AND SUMMARY

The present invention relates to a system for controlling the height of the chassis on a heavy vehicle, and in particular automatic controlling of the height based on information about i.e. the position of the vehicle.

The present invention relates to a method of adjusting the chassis height of vehicles, such as lorries with or without trailers, buses and other heavy vehicles, which include height adjusting devices, such as hydraulic or pneumatic suspension systems, for adjusting the chassis height.

The present invention is based on the finding that it is less time consuming and less fuel consuming, if the chassis heights are adjusted automatically for specific foreseen locations.

The chassis height of vehicles, in particular lorries, is often changed depending on the location of the vehicle. If for example the lorry is to be loaded or unloaded with goods, the chassis height is lowered or raised to the specific height corresponding to the height of the loading platform, and when the vehicle leaves the loading area, the chassis height is raised or lowered again to resume the proper driving height. If the vehicle later enters the motorway the chassis height must preferably be lowered in order to decrease the air resistance and thus decrease the fuel consumption. In such cases it will be less time consuming for the driver, if the chassis can be adjusted automatically based on the location of the vehicle, such that the chassis for example is adjusted to the height of the loading platform just before the vehicle enters the platform, or such that the chassis is lowered automatically when the vehicle enters the motorway in order to save fuel.

Today chassis height adjustment is controlled manually by the driver. It is known to have push-buttons in the drivers cabin having pre-set values for the chassis height, but these must be activated manually by the driver and thus not activated if the driver forgets to push the button, and often it only allows for two or three pre-set height values.

An aspect of the present invention provides a method and system for automatically adjusting the chassis height of the vehicle based on information of at least the position of the vehicle.

Thus, an aspect of the present invention provides a method of operating a vehicle system for automatically adjusting the chassis height of a vehicle, the method comprising operating height adjusting devices for adjusting the chassis in relation to one or more axles of the vehicle from a first height level to a second height level, and characterised in that the operation of height adjusting devices is controlled by positioning identification means so as to move the chassis from said first to said second height level in response to receiving from the position identification means an indication to the effect that the vehicle is approaching or has arrived at one of a plurality of predetermined positions and/or positions fulfilling predetermined criteria.

The chassis can be adjusted both upwards and downwards so the first height level may be lower or higher than said second height level, the operation of the height adjusting devices being controlled so as to move the chassis, when the position identification means identifies positions where a specific chassis height may be foreseen. The chassis front end respectively rear end can also be adjusted individually both upwards and downwards in order to adjust the inclination of the vehicle.

The height adjusting devices preferably forms part of the suspension system on the vehicle and comprise hydraulic or pneumatic adjusting devices. Thus, one or more fluid suppliers, preferably power driven air compressors or hydraulic pumps, supplies or removes fluid to/from said adjusting devices, and the operation of said one or more suppliers is controlled so as to supply or remove fluid to/from the adjusting device so as to lower or lift the chassis or adjust the inclination of the vehicle, when the position identification means identifies positions where a specific chassis height and/or inclination may be foreseen.

Alternatively, the height adjusting devices may comprise mechanical means for adjusting the height, such as arrangements with power driven screw spindles.

The vehicle system may be installed in a vehicle travelling regularly on a known route, said predetermined positions being selected based on experience and drive pattern recognition. As an example, a plurality of plots of the preferred chassis heights against the position along the route at different times of the day may be stored and used as a reference. Based on such experience and on the actual position of the vehicle, the chassis height level may be decided. For example data relating to heights of specific loading platforms may be stored in the vehicle system and used later on. If a lorry enters a loading area, the system will automatically adjust the chassis height and/or inclination so that the loading height of the trailer corresponds to the height of the loading platform.

The position identification means may be of any suitable kind being able to indicate when the vehicle is approaching or has arrived at one of a plurality of predetermined positions and/or positions where a specific chassis height may be expected. The indication received from the position indication means may, for example, be based on map data and other information about road topology (curves, road slopes, crossroads, tunnels), drive pattern recognition, traffic information from external sources, sensors located on the vehicle and/or special signals generated by external sources. The information may be received by and processed in an electronic processing system, and based on predetermined criteria this processing system may determine when the height of the chassis has to be changed.

In order to obtain the optimal chassis height during driving, the operation of the height adjusting devices or fluid suppliers may further be controlled based on the drivers preferred driving conditions, the type and amount of goods transported by the vehicle and/or the amount of fuel in the fuel tank.

The predetermined positions may comprise specific locations used for loading and/or unloading lorries and/or trailers or for coupling or uncoupling the trailer from the lorry where the chassis height must be adjusted, beginnings and ends of motorways, highways, streets, entrances and exits of loading areas and ferry terminals. Thus, when the vehicle e.g. enters the motorway or highway, the chassis height is adjusted downwards for lowering the chassis height in order to obtain better driving conditions and less fuel consumption, and when leaving the motorway or highway and e.g. entering a city or a ferry terminal the chassis is raised. Such “predetermined positions” may be defined by wireless position indicators, which may be arranged at suitable place at a certain distance in advance of such predetermined position, and which may be detected by a position detector installed in the vehicle.

The wireless position indicator may, for example, be a transponder transceiver and the position detector installed in the vehicle may be a transponding positioning receiver.

However, in a presently preferred embodiment the position identification means comprises a global navigation system (GPS, Global Positioning System) which may communicate with a receiver installed in the vehicle, and the operation of the adjusting devices may then be controlled based on the position indication received from the navigation system combined with information about the various positions stored.

Due to safety reasons, the operation of the height adjusting devices may further be based on information from velocity determining means determining the velocity of the vehicle. Preferably, the chassis height can only be adjusted within a narrow height range in relation to a neutral chassis height position when the vehicle is driving at a higher speed, e.g. above 10 km/h or 30 km/h. The chassis height can be adjusted in a wider height range when the vehicle is driving at a lower speed, e.g below 10 km/h or 30 km/h. Preferably, the system is adapted to adjust the chassis height within a range of preferably ±40 mm (meaning 40 mm upwards or downwards) from a predetermined neutral chassis height position (middle position) at any vehicle velocity, and to adjust the chassis height within a range of preferably plus 200 mm to minus 90 mm from said predetermined neutral chassis height position only at vehicle velocities being at the most e.g. 10 or 30 km/h.

The system may further comprise means for measuring the distance between the lowest part of the chassis and the ground, such that the chassis automatically can be raised in case the vehicle enters unforeseen areas or conditions, such as roads with very soft surface where the wheels dig into the ground.

According to a second aspect, the present invention relates to a vehicle comprising height adjusting devices for adjusting the height of the chassis in relation to one or more axles of the vehicle, height controlling means for controlling the height of the chassis in relation to the one or more axles, and position identification means for determining the position of the vehicle, and characterised in that a control device communicates with the position identification means, so as to change the height of the chassis from a first to a second height level in response to receiving from the position identification means an indication to the effect that the vehicle is approaching or has arrived at one of a plurality of predetermined positions and/or positions fulfilling predetermined criteria.

The height adjusting devices preferably comprise hydraulic or pneumatic adjusting devices operated by one or more fluid suppliers, preferably air compressors or hydraulic pumps, supplying or removing fluid to/from said adjusting devices, the operation of said one or more suppliers being controlled so as to supply or remove fluid to/from the adjusting device so as to move the chassis, when the position identification means identifies positions where a specific chassis height may be foreseen.

The control device may comprise a wireless receiver for communicating with a transmitter/receiver positioned in other vehicles and/or stationary units.

The vehicle may travel regularly on a known route, and said predetermined positions may then be selected based on experience. Said predetermined positions may be defined by wireless position indicators, such as transponder transceivers, positioned at or adjacent to said predetermined positions and which can be detected by a position detector installed in the, such as a transponding positioning receiver, adapted to communicate with the wireless position indicators.

However, in a presently preferred embodiment the position identification means comprises a global navigation system which may communicate with a receiver installed in the vehicle, and the operation of adjusting devices and/or the fluid supplier(s) may then be controlled based on the position indication received from the navigation system combined with information about the various positions stored, such as map data, information about topology, and combined with information about the preferred chassis heights at the positions.

The chassis height may also be dependent on the total axle load weight. Lower chassis height is needed when the vehicle, such as a lorry or truck, is empty than when it is fully loaded. Therefore, the vehicle preferably may include weight determining means, such as weight sensors or air bellow pressure sensors, for indicating the load weight. Such information about the load situation may be taken into consideration when controlling the operation of the chassis height adjusting devices/fluid suppliers.

The chassis height may also automatically be controlled by road information based on height limitations, as for example, low bridges, tunnels, construction sites, ferry ramps etc. Also clearance measuring devices, e.g. a device measuring the height of a bridge or the distance from the vehicle roof to a ceiling, can be used for controlling the vehicle height automatically. In this case, the vehicle can be lowered as much as possible in order to avoid, or at least to limit, damages caused be e.g. a low bridge.

It should be understood that in case the vehicle is a lorry with trailer, the chassis height of both the lorry and the trailer may be adjusted.

According to a third aspect the present invention relates a vehicle comprising a system according to the first aspect.

### BRIEF DESCRIPTION OF THE FIGURES

The invention will now be further described with reference to the figures, wherein

FIG. 1 is a side view showing a lorry with adjustable chassis height,

FIG. 2 is a perspective view of a lorry with height adjusting devices in the form of air bellows, and

FIG. 3 is a side view showing a lorry approaching a predetermined position.

### DETAILED DESCRIPTION

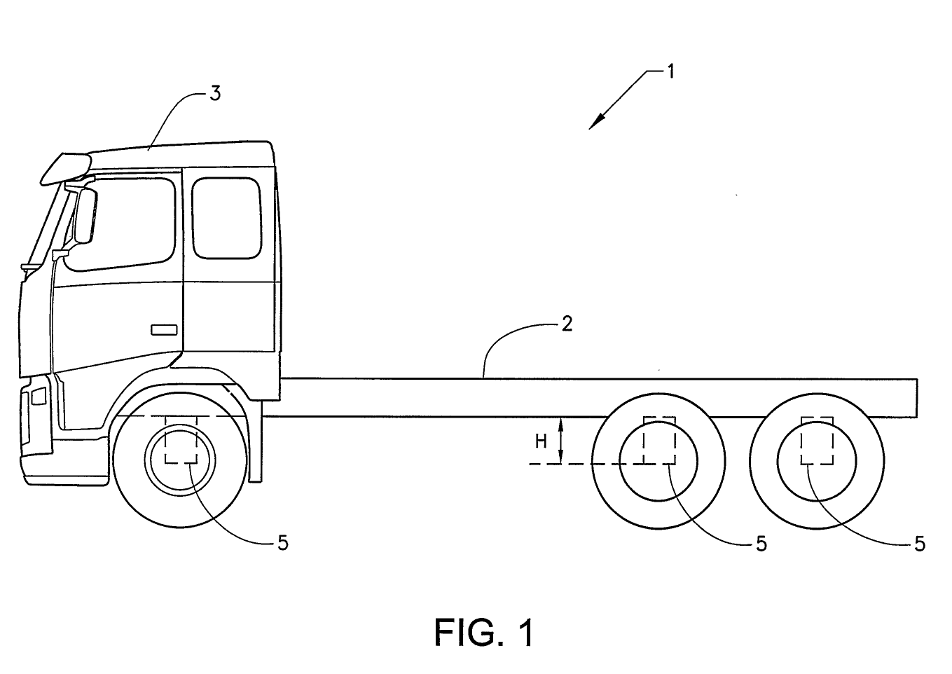

FIG. 1 illustrates a lorry 1 with a chassis 2 and a driver's cab 3 comprising a system according to the invention for automatically adjusting the chassis height (H) in relation to the axles by means of height adjusting devices 5.

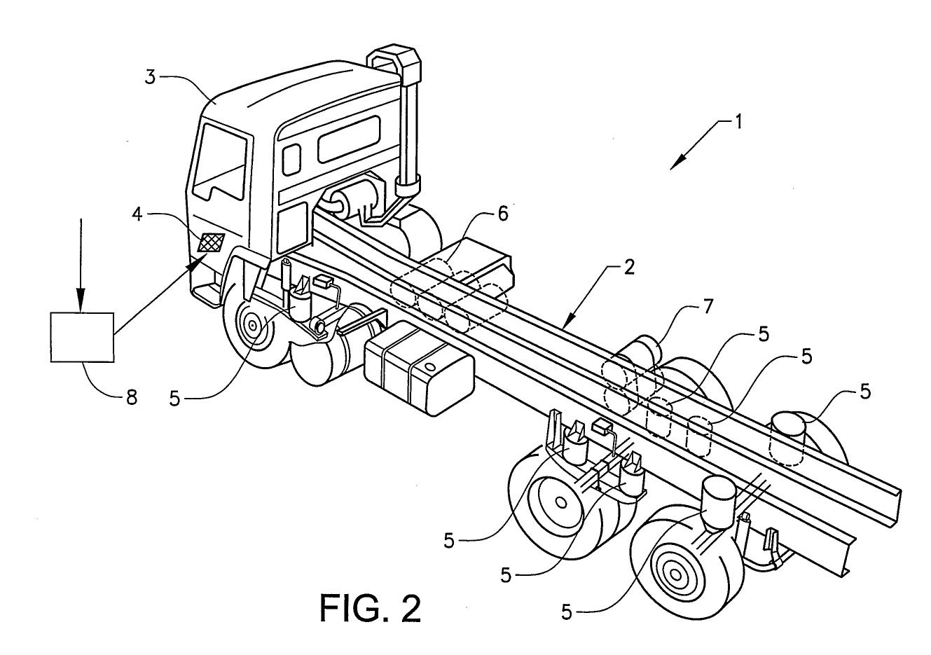

FIG. 2 is a perspective view showing a chassis 2 and the driver's cab 3 of a conventional lorry 1. The lorry 1 comprises a power driven air compressor 4 supplying air through storage tanks 6, 7 to a plurality of height adjusting air bellows 5 for adjusting the chassis height.

In this embodiment, the operation of the air suppliers 4, 6, 7 is controlled by an electronic control device 8 which may receive control signals from internal or external sources. When the chassis height is to be adjusted when a predetermined position is foreseen by the internal or external sources, a signal may be transmitted to the control device 8, which may then cause air to be supplied to or removed from the air bellows 5 depending on whether the chassis must be raised or lowered.

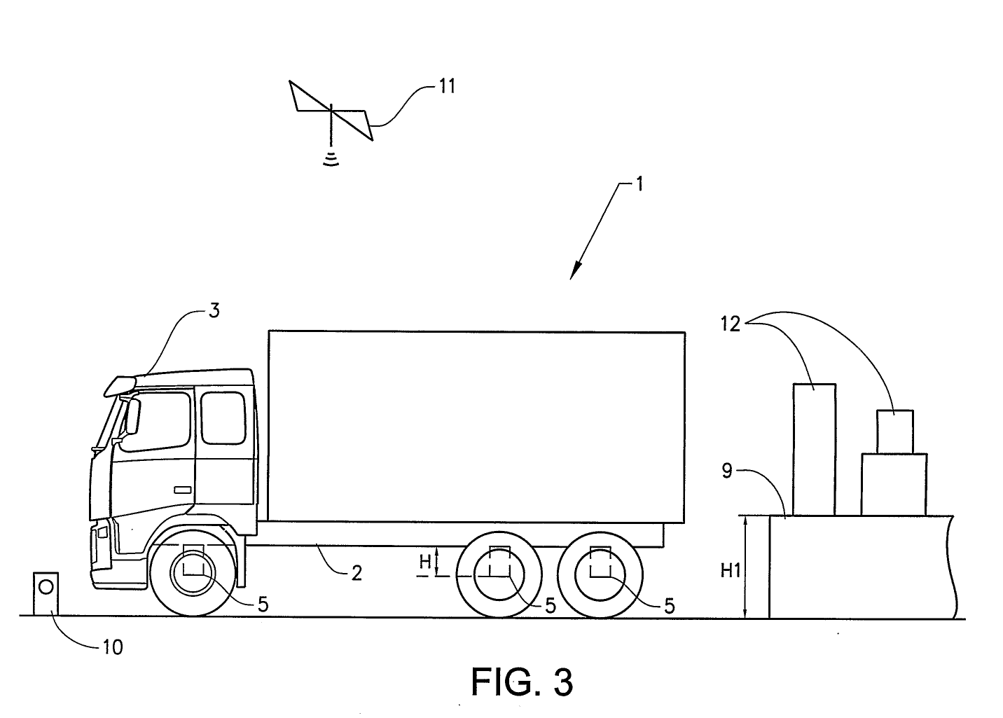

FIG. 3 illustrates a situation where a lorry 1 is approaching a loading platform 9 for loading goods 12 onto the lorry. In this case wireless position indicators, such as transponder transceivers 10 may be arranged along the sides of the lane to the platform or even prior to entering the loading area, and the control device 8 may comprise a wireless position detector, such a transponding position receiver. When the position detector of the control device receives a signal from the position indicators 10 indicating that the vehicle is approaching the loading platform 9 the control device 8 causes the air to be supplied to the height adjusting devices 5 in order to adjust the chassis height (H) so that the loading height of the trailer substantially corresponds to the height (H1) of to the loading platform 9. At the same time, the inclination of the vehicle may be adjusted in order to compensate for e.g. a sloping ground.

Alternatively or additionally the control device 8 may receive position data from satellites 11 of a global navigation system and combined with map information or topology data stored therein the control devices may decide to instruct the system to supply or remove air from the bellows 5.

It should be understood that numerous modifications and changes of the embodiments described above may be made within the scope of the appended claims. As an example the control device may receive signals from other kinds of external or internal signal sources than those described, such as video cameras, radar systems etc.

1. A method of operating a vehicle system for automatically adjusting the chassis height (H) of a vehicle (1), the method comprising:
operating height adjusting devices (5) for adjusting the chassis height (H) in relation to one or more axles of the vehicle (1) from a first height level to second height level,
characterised in
the operation of height adjusting devices (5) is controlled by positioning and/or condition identification means (10, 11) so as to move the chassis (2) from said first to said second height level in response to receiving from the position identification means (10, 11) an indication to the effect that the vehicle (1) is approaching or has arrived at one of a plurality of predetermined positions (9) and/or positions fulfilling predetermined criteria.

2. A method according to claim 1, wherein the height adjusting devices (5) comprise hydraulic or pneumatic adjusting devices (5), and wherein one or more fluid suppliers (4, 6, 7) supplies or removes fluid to/from said adjusting devices (5), the operation of said one or more suppliers being controlled so as to supply or remove fluid to/from the adjusting device (5) so as to move the chassis (2), when the position identification means (10, 11) identifies positions (9) where a specific chassis height (H) may be foreseen.

3. A method according to claim 1 or 2, wherein the vehicle system is installed in a vehicle travelling on a known route, said predetermined positions (9) being selected based on experience.

4. A method according to any of the claims 1-3, wherein said predetermined positions (9) are defined by wireless position indicators (10) to be detected by a position detector installed in the vehicle (1).

5. A method according to any of the claims 1-4, wherein the position identification means comprises a global navigation system (11).

6. A method according to any of the claims 1-5, wherein said predetermined positions comprise beginnings and ends of motorways, of highways, of streets, entrances and exits of loading areas and ferry terminals.

7. A method according to any of the claims 1-6, wherein said predetermined criteria comprises off road areas, rugged terrain, motorways or streets.

8. A method according to any of claims 1-7, wherein the operation of the height adjusting devices (5) further is based on information from velocity determining means determining the velocity of the vehicle.

9. A method according to claim 8, wherein the system is adapted to;
adjust the chassis height (H) within a first range from a predetermined neutral chassis height position at a vehicle velocity above a predetermined velocity, and
adjust the chassis height (H) within a second range from said predetermined neutral chassis height position at a vehicle velocity below said predetermined velocity.

10. A method according to claim 9, wherein the predetermined velocity is 10 km/h.

11. A method according to claim 9 or 10, wherein the first range is in the order of ±40 mm and the second range is in the order of plus 200 mm to minus 90 mm.

12. A method according to any of claims 1-11, wherein the operation of height adjusting devices (5) further is controlled based on drive pattern recognition, traffic information, the drivers preferred driving conditions, the type and amount of goods transported by the vehicle, the amount of fuel in the fuel tank and/or the recognised traffic or road conditions.

13. A vehicle (1) comprising;
height adjusting devices (5) for adjusting the height (H) of the chassis (2) in relation to one or more axles of the vehicle (1),
height controlling means for controlling the height of the chassis (2) in relation to the one or more axles, and
position identification means (10, 11) for determining the position of the vehicle,
characterised in
a control device (8) communicating with the position identification means (10, 11), so as to change the level of the height of the chassis (2) from a first to a second height level in response to receiving from the position identification means (10, 11) an indication to the effect that the vehicle (1) is approaching or has arrived at one of a plurality of predetermined positions (9) and/or positions fulfilling predetermined criteria.

14. A vehicle according to claim 13, wherein the height adjusting devices (5) comprise hydraulic or pneumatic adjusting devices (5), the vehicle comprising one or more fluid suppliers (4, 6, 7) to supply or remove fluid to/from said adjusting devices (5), the operation of said one or more suppliers being controlled so as to supply or remove fluid to/from the adjusting device so as to move the chassis (2), when the position identification means (10, 11) identifies positions (9) where a specific chassis height may be foreseen.

15. A vehicle according to claim 13 or 14, wherein the control device (8) comprises a wireless receiver for communicating with:
a global navigation system (11) and/or
transmitter/receiver positioned in other vehicles and/or
stationary units (10).

16. A vehicle according to any of the claims 13-15, the vehicle (1) travelling on a known route, said predetermined positions (9) being selected based on experience.

17. A vehicle according to any of the claims 13-16, wherein said predetermined positions (9) are defined by wireless position indicators (10) detected by a position detector installed in the vehicle.

18. A vehicle according to any of claims 13-17, wherein the control device (8) comprises a wireless position detector, such as a transponding positioning receiver, adapted to communicate with wireless position indicators, such as transponder transceivers, positioned at or adjacent to said predetermined positions.

19. A vehicle according to any of claims 13-18, wherein the height adjusting devices (5) forms part of the suspension system on the vehicle.

20. A vehicle according to any of the claims 13-19, further comprising vehicle velocity determining means communicating with the control device (8) so as to inform about the velocity of the vehicle, the control device (8) being adapted to take such information in consideration when controlling the operation of the height adjusting devices (5).

21. A vehicle (1) comprising a vehicle system according to any of claims 1-12.
